(19) United States
(12) Patent Application Publication
(10) Pub. No.: US 2012/0218145 A1
(43) Pub. Date: Aug. 30, 2012

(54) PSEUDOLITE-BASED NAVIGATION SYSTEM

(75) Inventors: Changdon KEE, Seoul (KR); Hyoungmin SO, Seoul (KR); Chongwon KIM, Seoul (KR)

(73) Assignee: SNU R&DB FOUNDATION, Seoul (KR)

(21) Appl. No.: 13/401,554

(22) Filed: Feb. 21, 2012

(30) Foreign Application Priority Data
Feb. 25, 2011 (KR) 10-2011-0017165

(51) Int. Cl. G01S 19/11

(52) U.S. Cl. 342/357.48

(57) ABSTRACT

The pseudolite-based navigation system includes: a plurality of pseudolites for transmitting a navigation signal which simulates a satellite signal transmitted from a plurality of GNSS satellites; and a portable device capable of calculating a navigation solution for a location thereof based on the signal received from the pseudolites, wherein the portable device includes: a GNSS receiver for receiving the navigation signal of the pseudolites and calculating a navigation solution based on the navigation signal; and a computing unit for calculating a final navigation solution by integrating the navigation solution calculated by the GNSS receiver and the location information of the GNSS satellites and the pseudolites.

### CROSS-REFERENCE TO RELATED APPLICATION

This application claims priority to Korean Patent Application No. 10-2011-0017165, filed on Feb. 25, 2011, and all the benefits accruing therefrom under 35 U.S.C. §119, the contents of which in its entirety are herein incorporated by reference.

### BACKGROUND

1. Field

The present disclosure relates to a pseudolite-based navigation system capable of precisely calculating a navigation solution by using a general common global navigation satellite system (GNSS) receiver and an additional computing unit, and more particularly, to a pseudolite-based navigation system capable of precisely calculating a navigation solution for a location of a portable device by receiving a navigation signal transmitted from a pseudolite that simulates and broadcasts a GNSS satellite signal and integrating arrangement information of the simulated GNSS satellite group and actual geometric arrangement information of a pseudolite.

2. Description of the Related Art

For the positioning using a GNSS satellite, a GNSS such as a Global Positioning System (GPS) has been used.

In a case of the satellite navigation system, since the intensity of radio wave sent from the GNSS satellite is weak, if a satellite is not observed due to geographic features so that the radio wave is not received, it is impossible to measure the location of the satellite. Therefore, the satellite navigation system is useable only at an outside place where the satellite is observed.

In order to overcome the above limit, there is used a pseudolite-based navigation system which may be used freely both indoors and outdoors by means of a pseudolite that generates and broadcasts a signal similar to the GNSS satellite signal.

However, in an existing pseudolite-based navigation system, in a case where a general common GNSS receiver is used, a portable device is not able to calculate a location solution if its hardware or software is not corrected, and the portable device may calculate the location solution only when a dedicated receiver is used.

### SUMMARY

In an existing pseudolite-based navigation system, navigation is allowed only when a GNSS receiver having a separate receiver program for processing a corresponding pseudolite signal is used. Therefore, a general portable device having a GNSS receiver may not be utilized in an existing pseudolite-based navigation system. The present disclosure is directed to providing a pseudolite-based navigation system which may precisely calculate a navigation solution even at a portable device having a general common GNSS receiver.

In one aspect, there is provided a pseudolite-based navigation system, including: a plurality of pseudolites for transmitting a navigation signal which simulates a satellite signal transmitted from a plurality of GNSS satellites; and a portable device capable of receiving location information of the GNSS satellites and actual installation location information of the pseudolites in advance, wherein the portable device calculates a navigation solution for a location thereof based on the signal received from the pseudolites, wherein the portable device includes: a GNSS receiver for receiving the navigation signal of the pseudolites and calculating a navigation solution based on the navigation signal; and a computing unit for calculating a final navigation solution by integrating the navigation solution calculated by the GNSS receiver and the location information of the GNSS satellites and the pseudolites.

The pseudolites of the pseudolite-based navigation system may set a reference point, and send a navigation signal corresponding to a satellite signal of the GNSS satellites which is considered as being received by a user located at the set reference point.

The pseudolite-based navigation system may further include a data server capable of calculating internally or receiving in advance the location information of the GNSS satellites corresponding to the pseudolites and the actual installation location information of the pseudolite, wherein the portable device may have a communication module and receive the signal, sent from the data server, through the communication module.

The navigation solution calculated by the GNSS receiver may be obtained in various ways such as a least squares method, a weighted least squares method, a direct calculating method, a filtering method or the like, but regardless of its calculating method or process, the calculation result may be expressed like Equation 4 below:

\hat{x}′=(H^{T}WH)⁻¹H^{T}W· z̅′ Equation 4

where \hat{x}′ is a navigation solution calculated by the GNSS receiver, H is a matrix for geometric information between the GNSS satellite and the reference point, z̅′ is a vector for a pseudo range measurement value processed by the GNSS receiver, and W is a matrix representing a weight. W may be selected in various ways, but specifically, W may be determined by using an inverse matrix of a covariance matrix of the measurement value.

The computing unit may calculate the final navigation solution according to Equation 11 below:

x̅=(G^{T}W′G)⁻¹G^{T}W′[H³⁰ z̅⁺−(H³⁰ l̅−H\hat{x}′)] Equation 11

where x̅ is a final navigation solution calculated by the computing unit, G=H³⁰H′, H⁺=H(H^{T}WH)⁻¹H^{T}W, H is a matrix for geometric information between the GNSS satellite and the reference point, H′ is a matrix for geometric information between the pseudolite and the GNSS receiver, z̅⁺ is a vector determined according to geometric location relations among the pseudolite, the GNSS receiver, the GNSS satellite and the reference point, l̅ is a vector determined according to a geometric location relation between the GNSS satellite and the reference point, \hat{x}′ is a navigation solution calculated by the GNSS receiver, and W′ is a matrix representing a weight. W′ may be selected in various ways, but specifically, W′ may be determined by using an inverse matrix of a covariance matrix of the calculated value of H⁺ z̅⁺−(H^{T} l̅−H\hat{x}′).

The W or W′ which is a matrix representing a weight in Equations 4 or 11 may be an identity matrix (I).

The pseudolite-based navigation system according to the present disclosure may calculate a navigation solution of a terminal by using a location calculation result of a general common receiver, even when a dedicated receiver is not provided.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view showing a pseudolite-based navigation system according to an embodiment of the present disclosure;

FIGS. 2a, 2b, 2c, and 2d are schematic views for illustrating the concept of a pseudolite navigation algorithm of the pseudolite-based navigation system according to the present disclosure; and

FIG. 3 is a schematic view for illustrating the pseudolite navigation algorithm of the pseudolite-based navigation system according to the present disclosure.

### DETAILED DESCRIPTION

Hereinafter, a pseudolite-based navigation system according to a preferred embodiment of the present disclosure will be described with reference to the accompanying drawings.

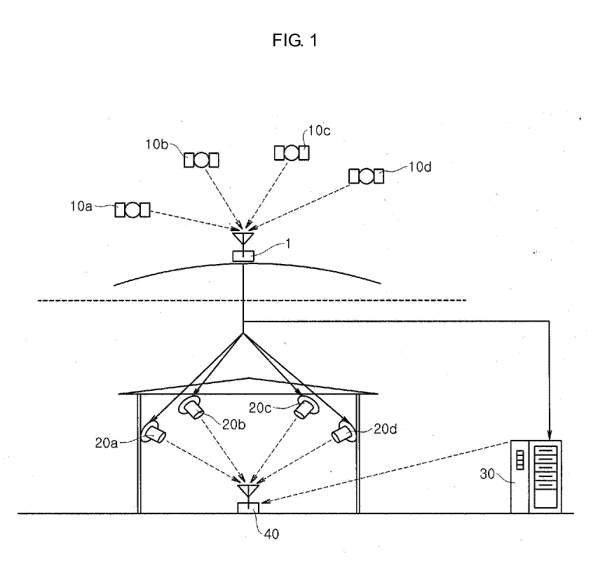

FIG. 1 is a schematic view showing a pseudolite-based navigation system according to an embodiment of the present disclosure.

Referring to FIG. 1, the pseudolite-based navigation system according to the present disclosure includes a plurality of virtual GNSS satellites 10a, 10b, 10c, 10d, a plurality of pseudolites 20a, 20b, 20c, 20d, and a portable device 40, and may further include a data server 30 selectively. The portable device 40 includes a communication module (not shown), a GNSS receiver (not shown) and a computing unit (not shown).

The pseudolites 20a, 20b, 20c, 20d generates and sends a navigation signal which simulates a virtual GNSS satellite signal, and transmits a navigation message having the same format and content as the GNSS satellite 10a, 10b, 10c, 10d. Here, the pseudolites 20a, 20b, 20c, 20d may simulate a virtual GNSS satellite signal or an actual GNSS satellite signal.

Each of the pseudolites 20a, 20b, 20c, 20d sets a reference point 1 arbitrary and sends a navigation signal corresponding to a satellite signal of each of the GNSS satellites 10a, 10b, 10c, 10d which is considered as being received at the reference point 1, and controls Doppler and code delay of the pseudolite signal to have the same physical properties as the GNSS satellite signal received at the corresponding reference point. The data server 30 sends locations of the GNSS satellites 10a, 10b, 10c, 10d and location information of the pseudolites 20a, 20b, 20c, 20d, which are stored in advance, to the portable device 40.

The data server 30 may calculate the locations of the GNSS satellites 10a, 10b, 10c, 10d and the location information of the pseudolites 20a, 20b, 20c, 20d by checking a combination of the virtual GNSS satellites 10a, 10b, 10c, 10d that configure the satellite navigation system (GNSS). In order to send a signal from the data server 30 to the portable device 40, for example, any of available wired/wireless communication links such as a wireless Internet and a mobile communication network may, be used.

The portable device 40 calculates a navigation solution of its location based on the signal received from the pseudolites 20a, 20b, 20c, 20d and the data server 30. In detail, the portable device 40 includes a communication module, a GNSS receiver and a computing unit.

The communication module receives location information of the GNSS satellites 10a, 10b, 10c, 10d and the pseudolites 20a, 20b, 20c, 20d, sent from the data server 30, and transmits the location information to the computing unit.

The GNSS receiver receives a navigation signal from the pseudolite 20a, 20b, 20c, 20d and calculates a navigation solution based on the navigation signal.

The computing unit calculates a final navigation solution by integrating the navigation solution calculated by the GNSS receiver and the location information of the GNSS satellites 10a, 10b, 10c, 10d and the pseudolites 20a, 20b, 20c, 20d.

Meanwhile, the pseudolite-based navigation system of the present disclosure may be configured without the data server 30. In this case, the portable device 40 receives the location information of the GNSS satellites and the actual installation location information of the pseudolites in advance.

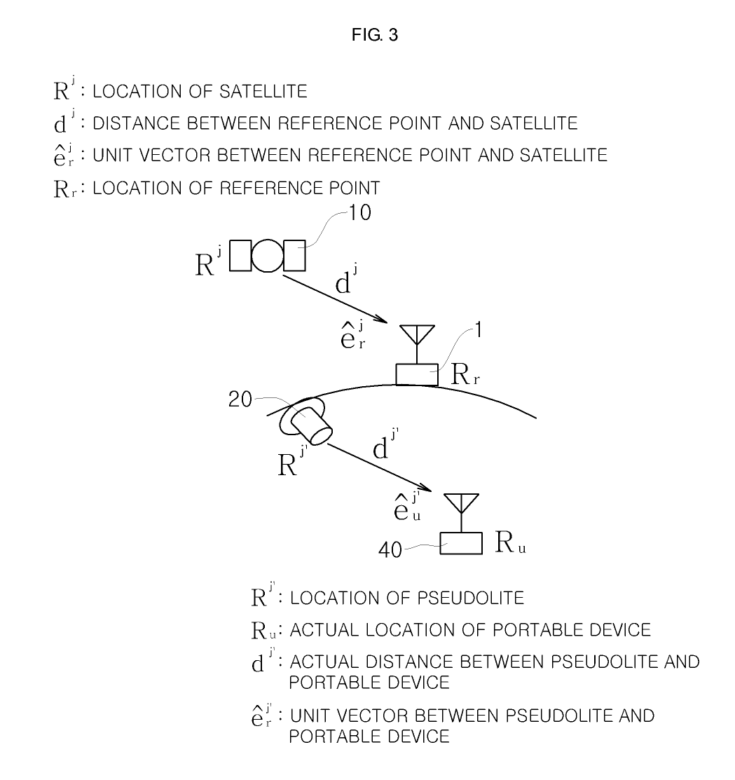

The process of calculating a navigation solution by the GNSS receiver and the process of calculating a final navigation solution by the computing unit will be described later with reference to FIG. 3.

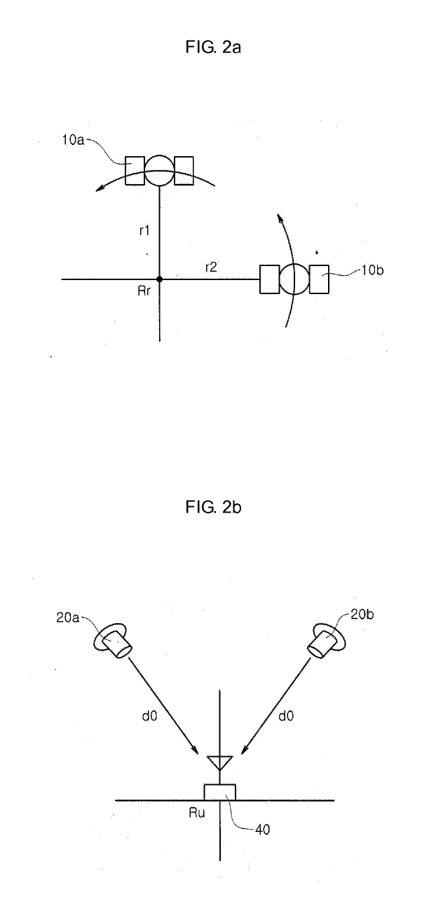

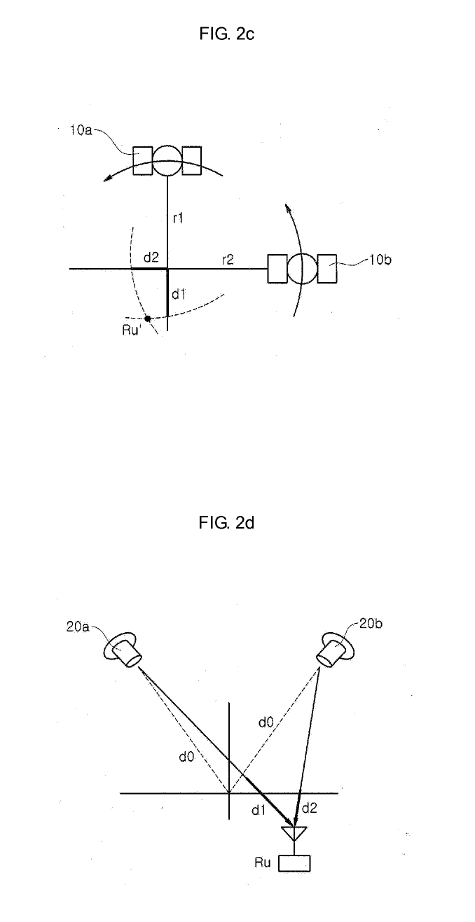

FIGS. 2a to 2d are schematic views for illustrating the concept of a pseudolite navigation algorithm of the pseudolite-based navigation system according to the present disclosure.

Referring to FIGS. 2a to 2d, in the pseudolite-based navigation system, the pseudolites 20a and 20b send the navigation signal which is generated by simulating the situation where the virtual GNSS satellite signal is received at the reference point Rr. Therefore, if a portable device 40 located at the same distance d0 from both of the pseudolites 20a and 20b receives navigation signals of the pseudolites 20a and 20b and performs navigation, the navigation result will be a reference point Rr.

In FIG. 2a, the GNSS receiver of the portable device 40 recognizes as the navigation signals are received from the GNSS satellites 10a and 10b separated by distances r1 and r2, respectively, instead of the pseudolites 20a and 20b. It is because the pseudolites 20a and 20b simulates the satellite signals of the GNSS satellites 10a and 10b and transmit the same navigation message as the GNSS satellites 10a and 10b. At this time, referring to FIG. 2b showing an actual situation, the signals sent from the pseudolites 20a and 20b commonly generate a delay as much as d0 when reaching the portable device 40, and the delay value is removed as a common error in a navigation calculation equation of the GNSS receiver so that the reference point location Rr is obtained as a navigation solution.

Meanwhile, as shown in FIG. 2d, in a case where the location of the portable device 40 changes from its original location, the signals sent from the pseudolites 20a and 20b generate delays of d0+d1 and d0+d2, respectively, when reaching the portable device 40, and a common portion d0 of the delay values is removed as a common error in the navigation calculating equation of the GNSS receiver. However, different from the above description, in this case, the delays remain as much as d1 and d2, and accordingly the navigation solution result Ru′ is obtained as corresponding to the arrangement of the GNSS satellites 10a and 10b.

The navigation solution Ru′ is calculated by the GNSS receiver of the portable device 40 and transmitted to the computing unit. In succession, the computing unit integrates the navigation solution Ru′ calculated by the GNSS receiver according to the pseudolite navigation algorithm and the geometric arrangement information of the GNSS satellites 10a and 10b and the pseudolites 20a and 20b transmitted from the data server 30. In succession, the computing unit obtains values including information of d1 and d2 under the actual pseudolite navigation environment as shown in FIG. 2d from reference points Rr and Ru′, and calculates a final navigation solution Ru of the actual portable device 40.

In an existing pseudolite navigation environment, it was impossible to calculate a location by using a general common receiver, if the hardware or firmware of the GNSS receiver is not corrected.. However, the pseudolite-based navigation system of the present disclosure corrects the navigation solution Ru′, calculated by an existing receiver, according to the geometric arrangement information of the GNSS satellites 10a and 10b and the pseudolites 20a and 20b so that the final navigation solution Ru of the actual portable device 40 may be calculated. Here, the navigation solution means information of the portable device (a navigating body) such as current location, speed, time or the like.

FIG. 3 is a schematic view for illustrating the pseudolite navigation algorithm of the pseudolite-based navigation system according to the present disclosure.

In FIG. 3, a pseudo range measurement value model processed by the GNSS receiver of the portable device 40 is expressed by Equation 1 below.

ρ^{j}=(R^{j}−Rᵤ^{′})·êᵣ^{j}+B′+ε′ Equation 1

where, ρ^{j} is a pseudo range measurement value of the portable device for a jth GNSS satellite,
R^{j} is a location of the GNSS satellite,
Rᵤ^{′} is a navigation solution calculated by the GNSS receiver,
êᵣ^{j} a unit vector between the reference point and the GNSS satellite,
B′ is a clock error of the portable device, and
ε′ is noise of the GNSS receiver.

In Equation 1, in the term where êᵣ^{j} is applied, a unit sight line vector between a user location and the GNSS satellite, calculated by the GNSS receiver, should be applied. However, since the height of the GNSS satellite is as high as 20000 km, if a location of a reference point is suitably selected, the unit sight line vector where the satellite is watched from the user location will have substantially the same value as the unit sight line vector where the satellite is watched from the reference point. Therefore, êᵣ^{j} representing the unit vector between the reference point and the GNSS satellite may be applied.

If the measurement value of Equation 1 is expanded for n number of satellites and Equation 1 is arranged with respect to Rᵤ^{′} and the GNSS receiver clock error term, Equation 2 below is obtained. Noise ε′ of the GNSS receiver is ignored.

$$[ \begin{matrix}{\hat{e}}_{r}^{1} & - 1 \\ ⋮ & ⋮ \\ {\hat{e}}_{r}^{n} & - 1\end{matrix} ] [ \begin{matrix}{R}_{n}^{′} \\ {B}^{′}\end{matrix} ] = ( \begin{matrix}{R}^{1} {\hat{e}}_{r}^{1} - {ρ}^{1} \\ ⋮ \\ {R}^{n} {\hat{e}}_{r}^{n} - {ρ}^{n}\end{matrix} ) = ( \begin{matrix}{l}^{1} - {ρ}^{1} \\ ⋮ \\ {l}^{n} - {ρ}^{n}\end{matrix} ) \qquad Equation 2$$

where, lⁿ is a value determined according to locations of the nth GNSS satellite and the reference point.

Equation 2 may be briefly arranged as in Equation 3 below.

H· x̅′= z̅′ Equation 3

where, H is a matrix for the geometric information between the GNSS satellite and the reference point,
x̅′ is a navigation solution calculated by the GNSS receiver, and
z̅′ is a vector for the pseudo range measurement values and lⁿ.

The navigation solution calculated from Equation 3 by the GNSS receiver may be obtained in various ways such as a least squares method, a weighted least squares method, a direct calculating method, a filtering method or the like, but regardless of its calculating method or process, the calculation result may be expressed like Equation 4 below.

x̅′=(H^{T}WH)⁻¹H^{T}W· z̅′ (Equation 4

where, \hat{x}′ is a navigation solution calculated by the GNSS receiver,

H is a matrix for the geometric information between the GNSS satellite and the reference point,

z̅′ is a vector for a pseudo range measurement value processed by the GNSS receiver, and

W is a matrix representing a weight.

W may be selected in various ways, but specifically, W may be determined by using an inverse matrix of a covariance matrix of the measurement value. The matrix W representing a weight may be an identity matrix I.

Meanwhile, if the information about the measurement value is estimated inversely from Equations 3 and 4, Equation 5 below may be obtained, and Equation 5 may be arranged like Equation 6 below.

$$\begin{matrix}{\hat{z}}^{′} ≡ H \cdot {\hat{x}}^{′} \\ = {H ( {H}^{T} WH )}^{- 1} {H}^{T} W \cdot {\overline{z}}^{′} \\ = {H}^{+} ( \overline{l} - \overline{ρ} )\end{matrix} \qquad Equation 5$$

where, H⁺=H(H^{T}WH)⁻¹H^{T}W

H⁺ ρ̅=H⁺ l̅−H\hat{x}′ Equation 6

In other words, a value including the pseudo range measurement value ρ̅ processed by the GNSS receiver may be estimated inversely by using the navigation solution \hat{x}′ transmitted from the GNSS receiver and the geometric information between the GNSS satellite and the reference point.

Referring to FIG. 3 again, an actual pseudo range measurement value model used for pseudolite navigation using a pseudolite signal which simulates the signal of the GNSS satellite is expressed by Equation 7 below.

$$\begin{matrix}{ρ}^{j} = {d}^{j} + {d}^{{j}^{′}} + B + ɛ \\ = ( {R}^{j} - {R}_{r} ) \cdot {\hat{e}}_{r}^{j} + ( {R}^{{j}^{′}} - {R}_{u} ) \cdot {\hat{e}}_{u}^{{j}^{′}} + B + ɛ\end{matrix} \qquad Equation 7$$

where, ρ^{j} is a pseudo range measurement value of the portable device for a jth GNSS satellite,
d^{j} is a distance between the reference point and the GNSS satellite,
d^{j′} is an actual distance between the pseudolite and the portable device,
B is a clock error of the portable device,
ε is noise of the GNSS receiver,
R^{j} is a location of the GNSS satellite,
Rᵣ is a location of the reference point,
êᵣ^{j} is a unit vector between the reference point and the GNSS satellite,
R^{j′} is a location of the pseudolite,
Rᵤ is an actual location of the portable device, and
êᵤ^{j′} is a unit vector between the pseudolite and the portable device.

If the measurement value of Equation 7 is expanded for n number of satellites and Equation 7 is arranged with respect to the user location and the GNSS receiver clock error term, Equation 8 below is obtained. Noise ε of the GNSS receiver is ignored.

$$[ \begin{matrix}{\hat{e}}_{u}^{{1}^{′}} & - 1 \\ ⋮ & ⋮ \\ {\hat{e}}_{u}^{{n}^{′}} & - 1\end{matrix} ] [ \begin{matrix}{R}_{u} \\ B\end{matrix} ] = ( \begin{matrix}{R}^{{1}^{′}} {\hat{e}}_{u}^{{1}^{′}} + ( {R}^{1} - {R}_{r} ) {\hat{e}}_{r}^{1} \\ ⋮ \\ {R}^{{n}^{′}} {\hat{e}}_{u}^{{n}^{′}} + ( {R}^{n} - {R}_{r} ) {\hat{e}}_{r}^{n}\end{matrix} ) - ( \begin{matrix}{ρ}^{1} \\ ⋮ \\ {ρ}^{n}\end{matrix} ) \qquad Equation 8$$

Equation 8 may be arranged briefly like Equation 9 below.

H′· x̅= z̅⁺− ρ̅ Equation 9

where, H′ is a matrix for the geometric information between the pseudolite and the GNSS receiver, and
x̅ is a final navigation solution calculated by the computing unit.

Equation 10 below is obtained from Equation 8 and Equation 6 above.

H⁺H′· x̅=H⁺ z̅⁺−H⁺ ρ̅

H⁺H′· x̅=H⁺ z̅⁺−(H⁺ l̅−H\hat{x}′) Equation 10

The final navigation solution calculated from Equation 10 by the computing unit may be calculated by using a least squares method as in Equation 11 below, and various estimation methods may also be applied thereto.

x̅=(G^{T}W′G)⁻¹G^{T}W′[H⁺ z̅⁺−(H⁺ l̅−H\hat{x}′) ] Equation 11

where x̅ is a final navigation solution calculated by the computing unit,

G=H⁺H′,

H⁺=H(H^{T}WH)⁻¹H^{T}W,

H is a matrix for geometric information between the GNSS satellite and the reference point,

H′ is a matrix for geometric information between the pseudolite and the GNSS receiver,

z̅⁺ is a vector determined according to geometric location relations among the pseudolite, the GNSS receiver, the GNSS satellite and the reference point,

l̅ is a vector determined according to a geometric location relation between the GNSS satellite and the reference point,

\hat{x}′ is a navigation solution calculated by the GNSS receiver, and

W′ is a matrix representing a weight.

W′ may be selected in various ways, but specifically, W′ may be determined by using an inverse matrix of a covariance matrix of the calculated value of H⁺ z̅⁺−(H⁺ l̅−H\hat{x}′). The matrix W representing a weight may be an identity matrix I.

From Equation 11, the computing unit may calculate the information about a location of the portable device 40. Meanwhile, when navigation signals are generated at the pseudolites 20a, 20b, 20c, 20d, various error components (ionosphere or convection layer error) may be considered so that the GNSS receiver may a navigation solution of Rr at any original point, or the result value of the GNSS receiver at any original point may be preset as Rr.

While the exemplary embodiments have been shown and described, it will be understood by those skilled in the art that various changes in form and details may be made thereto without departing from the spirit and scope of the present disclosure as defined by the appended claims. In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A pseudolite-based navigation system, comprising:
a plurality of pseudolites for transmitting a navigation signal which simulates a satellite signal transmitted from a plurality of GNSS satellites; and
a portable device capable of receiving location information of the GNSS satellites and actual installation location information of the pseudolites in advance, wherein the portable device calculates a navigation solution for a location thereof based on the signal received from the pseudolites,
wherein the portable device includes:
a GNSS receiver for receiving the navigation signal of the pseudolites and calculating a navigation solution based on the navigation signal; and
a computing unit for calculating a final navigation solution by integrating the navigation solution calculated by the GNSS receiver and the location information of the GNSS satellites and the pseudolites.

2. The pseudolite-based navigation system according to claim 1, wherein the pseudolites sets a reference point, and sends a navigation signal corresponding to a satellite signal of the GNSS satellites which is considered as being received by a user located at the set reference point.

3. The pseudolite-based navigation system according to claim 1, further comprising a data server capable of calculating internally or receiving in advance the location information of the GNSS satellites corresponding to the pseudolites and the actual installation location information of the pseudolite,wherein the portable device has a communication module and receives the signal, sent from the data server, through the communication module.

4. The pseudolite-based navigation system according to claim 1, wherein the navigation solution calculated by the GNSS receiver is expressed by Equation 4 below:
\hat{x}′=(H^{T}WH)⁻¹H^{T}W· z̅′ Equation 4
where \hat{x}′ is a navigation solution calculated by the GNSS receiver,
H is a matrix for geometric information between the GNSS satellite and the reference point,
z̅′ is a vector for a pseudo range measurement value processed by the GNSS receiver, and
W is a matrix representing a weight.

5. The pseudolite-based navigation system according to claim 4, wherein the computing unit calculates the final navigation solution according to Equation 11 below:
x̅=(G^{T}W′G)⁻¹G^{T}W′[H⁺ z̅⁺−(H⁺ l̅−H\hat{x}′)] Equation 11
where x̅ is a final navigation solution calculated by the computing unit,
G=H⁺H′,
H′=H(H^{T}WH)⁻¹H^{T}W,
H is a matrix for geometric information between the GNSS satellite and the reference point,
H′ is a matrix for geometric information between the pseudolite and the GNSS receiver,
z̅⁺ is a vector determined according to geometric location relations among the pseudolite, the GNSS receiver, the GNSS satellite and the reference point,
l̅ is a vector determined according to a geometric location relation between the GNSS satellite and the reference point,
\hat{x}′ is a navigation solution calculated by the GNSS receiver, and
W′ is a matrix representing a weight.

6. The pseudolite-based navigation system according to claim 4, wherein W or W′ which is a matrix representing a weight is an identity matrix (I).

7. The pseudolite-based navigation system according to claim 5, wherein W or W′ which is a matrix representing a weight is an identity matrix (I).
